(19) United States
(12) Patent Application Publication
(10) Pub. No.: US 2021/0051392 A1
(43) Pub. Date: Feb. 18, 2021

(54) Airlette (EarBud and Bracelet Combination)

(71) Applicant: Stephanie Ann Green, Milwaukie, OR (US)

(72) Inventor: Stephanie Ann Green, Milwaukie, OR (US)

(21) Appl. No.: 16/540,052

(22) Filed: Aug. 14, 2019

(51) Int. Cl. H04R 1/10

(52) U.S. Cl. CPC H04R 1/1091; H04R 1/1016; H04R 2420/07; H04R 2201/023; H04R 1/1041

(57) ABSTRACT

The purpose of this patent application is to obtain a patent on the Airlette, which is a combination between commercially available Earbuds and a commercially available fashion bracelet. The main purpose for this invention is to provide a convenient and discrete storage place for Earbuds when not in use. When the user needs the Earbuds, they unsnap it from the bracelet and start using it to talk. When they are finished talking, they snap the Earbuds back onto the bracelet and keep it there until they need to use it or charge it. If the user needs to charge it, he/she unsnaps the Earbuds from the bracelet and place it on the charger and charge it how the user normally charges the Earbuds.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention takes two existing commercially available products and combines them for a specific purpose or utility function. The main impetus for the Airlette, is to provide a convenient place for Earbuds (or any wireless apparatus that is inserted into the ear for wireless hearing of cell phone audible sounds) to store for easy access. Also, the main reason is to not to look obvious when using Earbuds that are connected through a wireless headset, or in a hard to find storage box that users have to quickly find in order to answer their phone. Many users never like to carry a case or wear a visible headset around their neck that contains obvious Earbuds. Out of need to have a discreet way to wear Earbuds, Stephanie invented the airlette, which makes the Earbuds look discreet while looking fashionable. The airlette will come in all styles, designs and colors. The Earbud is connected to the bracelet by either a magnet, snap, velcro or glue. The Earbuds will be attached in a discreet manner to the bracelet. The Earbuds will be incorporated into the design of the bracelet.

Stephanie Ann Green is a full-time working mother of 3 kids with an MBA. Her house is comprised of a family of five and her kids are always losing their wireless Earbuds. Stephanie noticed that existing accessories for Earbuds were lacking and wanted something more discrete and more fashionable. Hence the need for the invention of the airlette. The airlette's utility is a holding or storage facility, which is the bracelet, for the Earbuds to be connected to in order to access them quickly and efficiently as well as discretely while being fashionable.

### BRIEF SUMMARY OF THE INVENTION

As mentioned above, there is a huge market and need for this product. The invention is comprised of combining two separate commercially available products on the market currently into something that functions as its own utility (Earbuds and Bracelet combined make the airlette along with adherence material).

### BRIEF DESCRIPTION OF THE SEVERAL VIEWS OF THE DRAWING

Please refer to separate diagram of Airlette. Each element is properly labeled.

### DETAILED DESCRIPTION OF THE INVENTION

There is no other invention like this one the market. The process is simple with existing materials on the market. All materials are on the market currently so it's a matter of assembling existing materials that are commercially available. This invention requires the use of Earbuds and a bracelet and an adherence material such as magnets, snaps, velcro or glue. The adherence material is installed on the Earbuds and the same adherence material is placed on the bracelet and then the two are joined together in order to make a convenient and discreet storage space for the Earbuds. Essentially the two items are adhered together temporarily until the user needs the Earbuds, then he/she pulls the Earbuds off the bracelet and places them into their ears and starts using them. When the user is finished, he/she adheres the Earbuds back onto the bracelet. The Earbuds will be designed neatly into the bracelet to try and conceal it as much as possible or make it blend in with the design.

### DRAWINGS

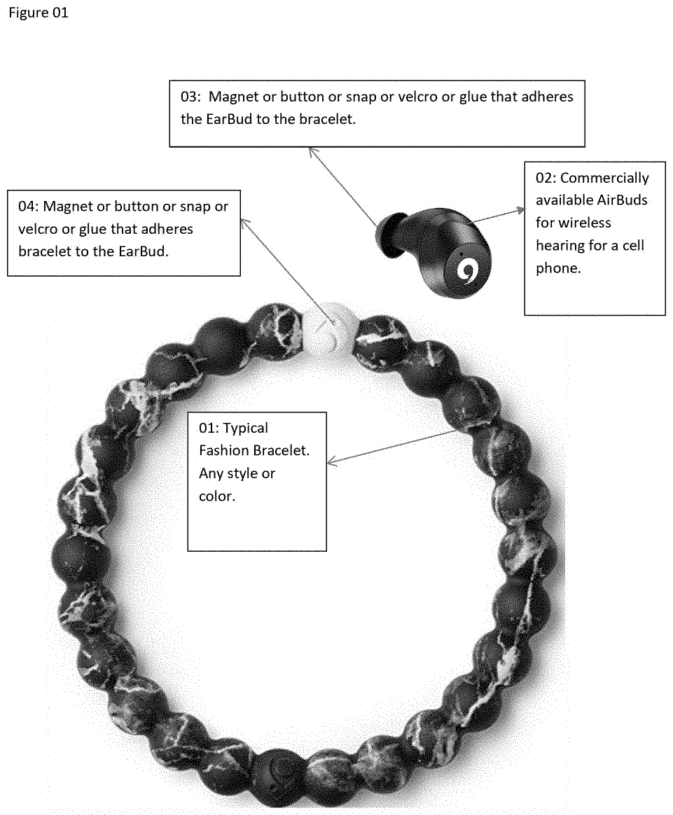

A sketch is attached as a separate drawing as FIG. 1.

Each item that is included in the drawing is labeled as follows:
01: Typical Fashion Bracelet. Any style or color.
02: Commercially available Earbuds for wireless hearing for a cell phone.
03: Magnet or button or snap or velcro or glue that adheres the EarBud to the bracelet.
04: Magnet or button or snap or velcro or glue that adheres bracelet to the EarBud.

1. Airlette is a combination of Earbuds (also known as a wireless apparatus that is inserted into the ear for wireless hearing of cell phone audible sounds) and a fashion bracelet that are temporarily adhered together in which makes a new idea and function. The user will wear the bracelet like a normal bracelet, but Earbuds, when not in use, are adhered to it in a discreet manner.
(a) An Earbud (wireless apparatus that is inserted into the ear for wireless hearing of cell phone audible sounds) that is adhered to a bracelet with adherence material such as magnets, glue, velcro and/or snaps.
(b) A fashion bracelet that has been designed to house Earbuds by means of an adherence material whereby the Earbuds are temporarily affixed to the bracelet until the user needs to use the Earbuds.
(c) A normal fashion bracelet that has Earbuds attached to it.
In this claim Earbuds and bracelets are already known and are not new. The bracelet with an Earbuds attached to it is the apparatus that is being claimed and patented.
For purposes of this patent, an Earbud is defined as a very small headphone, wom inside the ear in a wireless capacity.
For purposes of this patent, a bracelet is defined as an ornamental band, hoop, or chain wom on the wrist or arm.
